(19) United States
(12) Patent Application Publication
(10) Pub. No.: US 2013/0310294 A1
(43) Pub. Date: Nov. 21, 2013

(54) CT Natural Contrast Cleaner

(71) Applicant: Florence McCue-Morris, Land O'Lakes, FL (US)

(72) Inventor: Florence McCue-Morris, Land O'Lakes, FL (US)

(21) Appl. No.: 13/472,626

(22) Filed: May 16, 2012

(51) Int. Cl. C11D 3/04

(52) U.S. Cl. 510/109

(57) ABSTRACT

CT Natural Contrast Cleaner is a Saline based Cleaning solution, applied in Spray form, it cleans and effectively dissolves Iodine based Contrast Solution for Computed Tomography Scans. CT Contrast has typically had to be scraped and heated to be removed from floors and scanning equipment. CT Natural Contrast Cleaner allows for a simple spray and wipe cleaning of these spills. A surfactant has been added to the 0.80 saline solution to break the surface tention and allow for penetration of the saline. No product has previously filled this void in the market.

CT Natural Contrast Cleaner is a 0.80% Saline Solution. A non-toxic surfactant is added to the saline at a ratio of 120:1 by volume. The mixture is colored by the addition of approximately one drop per gallon of FD&C blue food coloring.

To mix:
Add 40 Gallons of water to a 50 gallon container
Mix in approximately seven lbs. of swimming pool grade Salt
Add 16 Liquid Ounces of BASF Inoterra DWF Surfactant (120:1 Ratio Saline to Surfactant)
Allow to stand overnight (8 to 10 hours) or mix with a circulation pump. You may also mix with a paddle mixer and then let stand 4 hours and repeat mixing.
Test with Salinity Refractometer and adjust mixture if needed to attain 0.80 salinity Repeat mixing if mixture is adjusted.
Add Food Grade Chemical Dye or food coloring to match color depicted below (approximately 1 drop per gallon).

[symbol]

Benefits:

Saline Solution, which is the primary make up of CT Natural Contrast Cleaner is generally used in medical settings as a dilution tool, such as eye wash, wound care, and of course Intravenous fluids and is therefore considered safe and hygienic.

CT Natural sprayed in a mist onto spills of Computed Tomography Contrast solution or Gadolinium contrast and allowed to stand momentarily (10 to 15 seconds), will dissolve the solution and allow for a simple wipe up of the spill. It may need to be repeated on stubborn or dried spills.

These spills have been cleaned in various ways up to now, including scraping, heating with wet rags or electric heaters, and even painting over them. No known “all purpose” cleaner has been able to clean these types of spills. This product is in use at several facilities with excellent results.

1. This invention was created by the stated inventor (Florence McCue-Morris) and is the sole property of the inventor and by assignment the company CT Natural Inc.
Saline solution naturally cleans sticky residue left by spills of Iodine based Computed Tomography Contrast solution. This fact was stumbled onto by Florence McCue-Morris while working as a CT Technologist. Tests were conducted to determine the most beneficial salinity and then retested to determine if any long-term build-ups were noted. A natural (BASF Inoterra DWF) surfactant has been added at a ratio of 120:1 with the saline solution to break surface tension of the cleaner when applied to a spill, and coloring has been added to enhance the look of the product.
As no problems occurred and the benefits were extreme the solution was formulated and this patent of the process is herein submitted.
